(19) United States
(12) Patent Application Publication
(10) Pub. No.: US 2026/0363275 A1
(43) Pub. Date: Nov. 19, 2026

(54) COMPOSITIONS AND METHODS FOR INCREASING THE PALATABILITY OF DRY DOG FOOD

(71) Applicant: Société des Produits Nestlé S.A., Vevey (CH)

(72) Inventors: Isaac N. A. Ashie, Ballwin, MO (US); Pascal Vanacker, AMIENS (FR); Deborah ROBERTS, SAVIGNY (CH)

(73) Assignee: Société des Produits Nestlé S.A., Vevey (CH)

(21) Appl. No.: 19/634,465

(22) Filed: Mar. 31, 2026

Related U.S. Application Data
(60) Provisional application No. 63/807,288, filed on May 16, 2025.

(51) Int. Cl. A23K 20/147; A23K 10/20; A23K 20/158; A23K 20/163; A23K 40/30; A23K 50/42

(52) U.S. Cl. CPC A23K 20/147; A23K 10/20; A23K 20/158; A23K 20/163; A23K 40/30; A23K 50/42

(57) ABSTRACT

Compositions and methods are provided directed to increased palatability of dry dog foods. A dry dog food composition can comprise from about 0.01 wt % to about 1 wt % of glutathione, wherein the glutathione is incorporated into a coating applied to the dry dog food composition.

### CROSS REFERENCE TO RELATED APPLICATIONS

This application claims the benefit of and priority to U.S. Provisional Application Ser. No. 63/807,288 filed May 16, 2025, the disclosure of which is incorporated in its entirety herein by this reference.

### BACKGROUND

The present disclosure generally relates to dog foods. More specifically, the present disclosure relates to compositions and methods for increasing the palatability of dry dog foods.

Of the main dog food categories, namely dry, semi-moist, and wet, dry dog foods are perceived as the least palatable. The existing solutions rely on optimizing the quality of raw materials (e.g. fat), increasing the moisture of the product, or increasing the application rate of flavor systems. The main drawback of these solutions is availability of the materials and/or the cost. Therefore, there remains a need for new compositions and methods that can provide increased palatability for dry dog food compositions that avoid the shortcomings of current solutions.

### SUMMARY

The present disclosure provides compositions and methods for increasing the palatability of dry dog foods using glutathione. The present inventors have unexpectedly discovered that glutathione can significantly increase palatability of a dry dog food composition.

As such, in one embodiment, a dry dog food composition can comprise about 0.01 wt % to about 1 wt % of glutathione. The glutathione can be incorporated into a coating applied to the dry dog food composition.

In another embodiment, a method of making a dry dog food composition can comprise providing a basal body of dog food; incorporating about 0.01 wt % to about 1 wt % of a glutathione based on the total weight of the dry dog food into a coating; and applying the coating to the basal body of dog food.

An advantage of the present disclosure is to improve the palatability of dry dog food.

Another advantage of the present disclosure is to use an economical and readily available compound as a palatant for dog food.

Still another advantage of the present disclosure is to improve the palatability of dry dog food without relying on optimizing the quality of raw materials (e.g. fat), increasing the moisture of the product, or increasing the application rate of flavor systems.

Additional features and advantages are described in, and will be apparent from, the following Detailed Description.

### DETAILED DESCRIPTION

All percentages expressed herein are by dry matter weight of the total weight of the composition and can be expressed as “wt %” unless expressed otherwise.

The term “dog” and “canine” are used interchangeably herein.

The term “dog food composition” or “dog food” means any composition intended to be consumed by a dog.

The term “dry food” or “dry dog food” refers to a dog food having less than 10 wt. % moisture and/or a water activity less than 0.64, and in one aspect, both. “Kibbles” are pellets of dry dog food, and in one aspect, can be extruded pellets. A “basal body” is a pellet of dry dog food and does not include the coating, if any. A “basal composition” is a composition processed to form the basal body. A “semi-moist” food composition has 11 wt. % to 20 wt. % moisture and/or a water activity of 0.64 to 0.75, and in one aspect, both.

The term “complete and balanced” when referring to a food composition means a food composition that contains all known required nutrients in appropriate amounts and proportions based on recommendations of recognized authorities in the field of animal nutrition, and are therefore capable of serving as a sole source of dietary intake to maintain life or promote production, without the addition of supplemental nutritional sources. Nutritionally balanced dog food and animal food compositions are widely known and widely used in the art, e.g., complete and balanced food compositions formulated according to standards established by the Association of American Feed Control Officials (AAFCO) as of Jan. 1, 2025.

As used herein and in the appended claims, the singular form of a word includes the plural, and vice versa, unless the context clearly dictates otherwise. Thus, the references “a,” “an” and “the” are generally inclusive of the plurals of the respective terms. For example, reference to “a compound” or “a method” includes a plurality of such “compounds” or “methods.”

Similarly, the words “comprise,” “comprises,” and “comprising” are to be interpreted inclusively rather than exclusively. Likewise, the terms “include,” “including” and “or” should all be construed to be inclusive, unless such a construction is clearly prohibited from the context. However, the embodiments provided by the present disclosure may lack any element that is not specifically disclosed herein. Thus, a disclosure of an embodiment defined using the term “comprising” also is a disclosure of embodiments “consisting essentially of” and “consisting of” the disclosed components. Where used herein, the term “example,” particularly when followed by a listing of terms, is merely exemplary and illustrative, and should not be deemed to be exclusive or comprehensive. Any embodiment disclosed herein can be combined with any other embodiment disclosed herein.

As used herein, “about” is understood to refer to numbers in a range of numerals, for example the range of −10% to +10% of the referenced number, within −5% to +5% of the referenced number, or in one aspect, within −2% to +2% of the referenced number, and in a specific aspect, within −1% to +1% of the referenced number. Furthermore, all numerical ranges herein should be understood to include all integers, whole or fractions, within the range. Moreover, these numerical ranges should be construed as providing support for a claim directed to any number or subset of numbers in that range. For example, a disclosure of from 1 to 10 should be construed as supporting a range of from 1 to 8, from 3 to 7, from 1 to 9, from 3.6 to 4.6, from 3.5 to 9.9, and so forth.

All patents, patent applications, publications, and other references cited or referred to herein are incorporated herein by reference to the extent allowed by law. The discussion of those references is intended merely to summarize the assertions made therein. No admission is made that any such patents, patent applications, publications or references, or any portion thereof, are relevant prior art for the present invention and the right to challenge the accuracy and pertinence of such patents, patent applications, publications, and other references is specifically reserved.

The inventors surprisingly found that glutathione increased palatability of dry dog food compositions. Accordingly, the present disclosure provides compositions and methods for increasing the palatability of dry dog food, such as dry dog food kibbles. The compositions generally comprise glutathione.

As such, in one embodiment, a dry dog food composition can comprise about 0.01 wt % to about 1 wt % of glutathione. The glutathione can be incorporated into a coating applied to the dry dog food composition.

In another embodiment, a method of making a dry dog food composition can comprise providing a basal body of dog food; incorporating about 0.01 wt % to about 1 wt % of a glutathione based on the total weight of the dry dog food into a coating; and applying the coating to the basal body of dog food.

In yet another embodiment, a method for increasing the palatability of dry dog food can comprise incorporating about 0.01 wt % to about 1 wt % of glutathione into a coating applied to the dry dog food composition.

Generally, the total amount of glutathione can be from about 0.01 wt % to about 1 wt %. In various aspects, the total amount of glutathione can be from about 0.01 wt %, 0.02 wt %, 0.03 wt %, 0.04 wt %, 0.05 wt %, 0.06 wt %, 0.07 wt %, 0.08 wt %, 0.09 wt % 0.1 wt %, 0.2 wt %, 0.3 wt %, 0.4 wt %, 0.5 wt %, 0.6 wt %, 0.7 wt %, 0.8 wt %, or even 0.9 wt % to about 0.02 wt %, 0.03 wt %, 0.04 wt %, 0.05 wt %, 0.06 wt %, 0.07 wt %, 0.08 wt %, 0.09 wt % 0.1 wt %, 0.2 wt %, 0.3 wt %, 0.4 wt %, 0.5 wt %, 0.6 wt %, 0.7 wt %, 0.8 wt %, 0.9 wt % or even 1 wt %. In one aspect, the glutathione can be present in an amount from about 0.01 wt % to about 0.5 wt % of the dry dog food composition.

In another embodiment, the total amount of glutathione can be from about 1 wt % to about 10 wt % of the coating. In other aspects, the a total amount of glutathione can be from about 1 wt %, 2 wt %, 3 wt %, 4 wt %, 5 wt %, 6 wt %, 7 wt % or even 8 wt % to about 2 wt %, 3 wt %, 4 wt %, 5 wt %, 6 wt %, 7 wt %, 8 wt %, 9 wt %, or even 10 wt % of the coating.

Additionally, the coating can include various additives and components as known in the art. For example, in one embodiment, the coating can contain liquid animal digest. In another embodiment, the coating can contain fat.

In an embodiment, the dry dog food can comprise at least one vitamin and/or at least one mineral. Non-limiting examples of suitable vitamins include vitamin A, any of the B vitamins (e.g., B-1, B-2, B-3, B-5, B-6, B-7, B-9, and B-12), vitamin C, vitamin D, vitamin E, and vitamin K, including various salts, esters, or other derivatives of the foregoing. Non-limiting examples of suitable minerals include calcium, phosphorous, potassium, sodium, iron, chloride, boron, copper, zinc, magnesium, manganese, iodine, selenium, and the like. In one embodiment, the dry dog food composition can be a complete and nutritionally balanced dog food.

In an embodiment, the dry dog food comprises from about 5% to about 70% crude protein. The crude protein can comprise vegetable proteins, such as whole grain wheat, whole grain corn, soybean meal, soy protein concentrate, corn gluten meal, wheat gluten, cottonseed, and peanut meal; or animal proteins, such as casein, albumin, and meat protein. Non-limiting examples of suitable meat protein include beef, pork, lamb, rabbit, poultry, fish, and mixtures thereof. Non-limiting examples of suitable meat meals include rendered and ground parts from beef, pork, lamb, rabbit, poultry, fish, insects, and mixtures thereof. Non-limiting examples of suitable meat include any meat and meat by-product such as whole-carcass beef and mutton; lean pork trim; beef shanks; veal; beef and pork cheek meat; and meat by-products such as lips, tripe, hearts, tongues, mechanically deboned beef, chicken or fish, beef and pork liver, lungs, kidneys, and the like. The meat can be emulsified or particulate. In an embodiment, the meat is chicken. In one embodiment, the dry dog food compositions can comprise protein in amounts from about 5%, 10%, 15%, 20%, 25%, 30%, 35%, 40%, 45%, 50%, or even 55% to about 20%, 25%, 30%, 35%, 40%, 45%, 50%, 55%, 60%, 65%, or even 70% by weight, including various subranges within these amounts.

In an embodiment, the dry dog food comprises from about 5% to about 50% fat. Non-limiting examples of suitable fats include animal fats and vegetable fats. Preferably the fat source is an animal fat source, for example, beef fat, pork fat, poultry fat. Vegetable oils, such as corn oil, sunflower oil, safflower oil, rapeseed oil, soybean oil, olive oil and other oils rich in monounsaturated and polyunsaturated fatty acids, and medium chain triglycerides can be used. In one embodiment, the dry dog food compositions can comprise fat in amounts from about 5%, 10%, 15%, 20%, 25%, 30%, 35%, 40%, or even 45% to about 20%, 25%, 30%, 35%, 40%, 45%, or even 50% by weight, including various subranges within these amounts.

In an embodiment, the dry dog food comprises from about 5% to about 60% carbohydrate. Non-limiting examples of suitable carbohydrates include grains or cereals such as rice, corn, millet, sorghum, alfalfa, barley, soybeans, canola, oats, wheat, rye, triticale and mixtures thereof. The compositions can comprise other materials such as dried whey and other dairy by-products. In one embodiment, the dry dog food compositions can comprise protein in amounts from about 5%, 10%, 15%, 20%, 25%, 30%, 35%, 40%, 45%, 50%, or even 55% to about 20%, 25%, 30%, 35%, 40%, 45%, 50%, 55%, or even 60% by weight, including various subranges within these amounts.

In an embodiment, the dry dog food comprises one or more fiber sources. The term “fiber” includes all sources of “bulk” in the food whether digestible or indigestible, soluble or insoluble, fermentable or non-fermentable. Preferred fibers are from plant sources such as marine plants, but microbial sources of fiber may be used. Soluble fibers and/or insoluble fibers may be utilized. Non-limiting examples of suitable fiber sources include beet pulp (from sugar beet), gum arabic, psyllium, rice bran, carob bean gum, citrus pulp, pectin, fructooligosaccharide, short chain oligofructose, mannanoligofructose, soy fiber, arabinogalactan, galactooligosaccharide, arabinoxylan, and mixtures thereof.

The fiber source can be a fermentable fiber. Fermentable fiber has previously been described to provide a benefit to the immune system of a companion animal. Fermentable fiber or other compositions known to skilled artisans that provide a prebiotic to enhance the growth of probiotics within the intestine may be incorporated into the dry dog food.

In some embodiments, the ash content of the dry dog food ranges from less than 1% to about 15%, preferably from about 5% to about 10%.

In various embodiments, the dry dog food compositions may comprise additional ingredients such as amino acids, nucleic acids, fillers, palatability enhancers, binding agents, flavorants, stabilizers, emulsifiers, sweeteners, colorants, buffers, salts, coatings, condiments, preservatives, and the like known to skilled artisans. Non-limiting examples of antioxidants include butylated hydroxyanisole (“BHA”) and butylated hydroxytoluene (“BHT”), vitamin E (tocopherols), and the like. Non-limiting examples of suitable preservatives include potassium sorbate, sorbic acid, sodium methyl para-hydroxybenzoate, calcium propionate, propionic acid, and combinations thereof. The compositions may also comprise carotenoids such as alpha-carotene, lycopene, lutein, zeaxanthin and beta-cryptoxanthin. Additional ingredients may also be included, for example, digestive aids, health aids, and the like.

Examples of suitable flavorants include yeast, tallow, rendered animal meals (e.g., poultry, beef, lamb, pork), flavor extracts or blends (e.g., grilled beef), and the like. Suitable colorants that may be used in the meat analog chunks and/or the gravy include FD&C colors, such as blue no. 1, blue no. 2, green no. 3, red no. 3, red no. 40, yellow no. 5, yellow no. 6, and the like; natural colors, such as caramel coloring, annatto, chlorophyllin, cochineal, betanin, turmeric, saffron, paprika, lycopene, elderberry juice, pandan, butterfly pea and the like; titanium dioxide; iron oxides; and any suitable food colorant known to the skilled artisan. Suitable spices that may be used in the meat analog chunks and/or the gravy include parsley, oregano, sage, rosemary, basil, thyme, chives and the like.

The dry dog foods disclosed herein are formulated for consumption by a dog. In an embodiment, the dry dog food provides complete nutrition as defined by the Association of American Feed Control Officials (AAFCO) and which depends on the type of animal for which the composition is intended (e.g., a dog or a cat). In another embodiment, the composition can be a supplement or a treat. Such a supplement or treat can be added to a food composition or be administered in conjunction with a food composition, or administered separately. In some embodiments where the composition is a supplement or a treat, to enhance the length of time the supplement can be stored, the dietary supplements or treats can have a total moisture content between about 2% and about 10% by weight of the supplement or treat. In one embodiment, the total moisture content can be less than 5% by weight of the supplement or treat. Similarly, the dietary supplement or treat can have a water activity in the range of 0.20 to 0.6. In one aspect, the water activity can be less than 0.55.

Selection of the amounts of each additional ingredient is known to skilled artisans. Specific amounts for each additional ingredient will depend on a variety of factors such as the ingredient included in the coating composition; the species of animal; the animal's age, body weight, general health, sex, and diet; the animal's consumption rate; the purpose for which the dog food is administered to the animal; and the like. Therefore, the identity and amounts of the additional ingredients may vary widely and may deviate from the preferred embodiments described herein.

The present disclosure also provides methods for making dry dog food. In one embodiment, a method of making a dry dog food composition can comprise providing a basal body of dog food, incorporating about 0.01 wt % to about 1 wt % of a glutathione based on the total weight of the dry dog food into a coating, and applying the coating to the basal body of dog food.

In one embodiment, providing a basal body can include admixing protein, fat, and carbohydrates, into an admixture and extruding the admixture to form the basal body of dog food. In one aspect, the ingredients of the dry basal composition are milled, for example by a hammer mill. The milled ingredients can be extruded and expanded, and as the ropes exit the extruder they are cut into kibbles by rotating knives or another suitable cutting device. The kibbles can be dried to a moisture content less than about 20%, preferably less than about 15%, and more preferably less than about 10%.

Generally, the dry kibbles can be coated with a coating composition that includes glutathione, for example by spraying. The coating composition can include animal fat and palatants. Non limiting examples of palatants are liquid or dried hydrolyzed animal by-product parts (also referred to as liquid animal digest or dried animal digest), whole yeast, autolyzed yeast, yeast extract, plant oils, and other flavor compounds known to those skilled in the art. In one embodiment, the coating composition includes animal fat and hydrolyzed animal by-products. In one aspect, the coating can comprise liquid animal digest, fat, or both. The kibbles can then be filled into suitable packaging which is subsequently sealed.

### EXAMPLES

By way of example and not limitation, the following non-limiting examples are illustrative of various embodiments provided by the present disclosure.

### Example 1—Dry Dog Food Study

One panel of 20 dogs were used to study the effect of glutathione when applied on dry dog food as a coating. A premium pet food, Purina® Dog Chow Complete Chicken & Rice, was used as a basis for a paired test. Purina® Dog Chow Complete Chicken & Rice was the control diet and the test diet was Purina® Dog Chow Complete Chicken & Rice with glutathione added as a coating. Diets with inclusion amounts and the palatability results are in Table 1.

TABLE 1

| | Glutathione Amount | Consumption (%) |
|---|---|---|
| Composition | (wt % of dog food) | vs. Control |
| Purina ® Dog Chow (Test) | 0.05 | 77.5 |
| Purina ® Dog Chow (Test) | 0.1 | 80.1 |
| Purina ® Dog Chow (Test) | 0.15 | 76.8 |
| Purina ® Dog Chow (Test) | 0.2 | 61.7 |

As can be seen from Table 1, glutathione provided a palatability increase over various concentrations. The test was replicated with a super-premium dog food, Purina® Pro Plan Veterinary OM Diet, which was used as a basis for a paired test. Purina® Pro Plan Veterinary OM Diet was the control diet and the test diet was Purina® Pro Plan Veterinary OM Diet with glutathione added as a coating. Diets with inclusion amounts and the palatability results are in Table 2.

TABLE 2

| | Glutathione Amount | Consumption (%) |
|---|---|---|
| Composition | (wt % of dog food) | vs. Control |
| Purina ® Pro Plan | 0.04 | 59 |
| Veterinary Diet (Test) | | |
| Purina ® Pro Plan | 0.2 | 74 |
| Veterinary Diet (Test) | | |

As can be seen from Table 2, glutathione again provided a palatability increase.

### Example 2—Cat Study

Two panels of 20 cats were used to study the effect of glutathione when applied on dry cat food as a coating. A pet food, Purina® Cat Chow Chicken & Rice, was used as a basis for a paired test. Purina® Cat Chow Chicken & Rice was the control diet and the test diet was Purina® Cat Chow® Chicken & Rice with glutathione added as a coating. Diets with inclusion amounts and the palatability results are in Table 3.

TABLE 3

| | Glutathione Amount | Consumption (%) |
|---|---|---|
| Composition | (wt % of dog food) | vs. Control |
| Purina ® Cat Chow ® (Test) | 0.05 | 39.3 |
| Purina ® Cat Chow ® (Test) | 0.1 | 45.5 |
| Purina ® Cat Chow ® (Test) | 0.15 | 49.6 |
| Purina ® Cat Chow ® (Test) | 0.2 | 48.3 |

As can be seen in Table 3, glutathione did not provide an effect in dry cat foods. Additionally, a water study was performed and showed no palatability effect for cats.

As can be seen from the present examples, glutathione unexpectedly only provides palatability effects for dogs.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A dry dog food composition comprising from about 0.01 wt % to about 1 wt % of glutathione, wherein the glutathione is incorporated into a coating applied to the dry dog food composition.

2. The dry dog food composition of claim 1, wherein the glutathione is present in an amount from about 0.01 wt % to about 0.5 wt % of the dry dog food composition.

3. The dry dog food composition of claim 1, wherein the coating contains liquid animal digest.

4. The dry dog food composition of claim 1, wherein the coating contains fat.

5. The dry dog food composition of claim 1, further comprising protein, fat, and carbohydrates.

6. The dry dog food composition of claim 5, wherein the protein is present in an amount from about 5 wt % to about 70 wt %, the fat is present in an amount from about 5 wt % to about 50 wt % and the carbohydrate is present in an amount from about 5 wt % to about 60 wt %, wherein the amounts are based on the total weight of the dry dog food composition.

7. The dry dog food composition of claim 1, wherein the dry dog food composition is a complete and nutritionally balanced dog food.

8. The dry dog food composition of claim 1, wherein the dry dog food composition is a supplement or a treat.

9. A method of making a dry dog food composition comprising:
providing a basal body of dog food;
incorporating about 0.01 wt % to about 1 wt % of a glutathione based on the total weight of the dry dog food into a coating; and
applying the coating to the basal body of dog food.

10. The method of claim 9, wherein the providing comprises admixing protein, fat, and carbohydrates, into an admixture and extruding the admixture to form the basal body of dog food.

11. The method of claim 10, wherein the protein is present in an amount from about 5 wt % to about 70 wt %, the fat is present in an amount from about 5 wt % to about 50 wt % and the carbohydrate is present in an amount from about 5 wt % to about 60 wt %, wherein the amounts are based on the total weight of the dry dog food composition.

12. The method of claim 9, wherein the glutathione is present in an amount from about 0.01 wt % to about 0.5 wt % of the dry dog food composition.

13. The method of claim 9, wherein the coating comprises liquid animal digest, fat, or both.

14. The method of claim 9, wherein the dry dog food composition is a complete and nutritionally balanced dog food.

15. The method of claim 9, wherein the dry dog food composition is a supplement or a treat.
